(19) United States
(12) Patent Application Publication
(10) Pub. No.: US 2012/0297706 A1
(43) Pub. Date: Nov. 29, 2012

(54) THERMAL WINDOW ASSEMBLY

(75) Inventor: Denis Bourdon, Ottawa (CA)

(73) Assignee: ALVEUS INNOVATIONS INC., Ottawa (CA)

(21) Appl. No.: 13/415,369

(22) Filed: Mar. 8, 2012

Related U.S. Application Data
(60) Provisional application No. 61/489,384, filed on May 24, 2011.

(51) Int. Cl. E06B 3/66; E04G 23/00; E06B 1/36

(52) U.S. Cl. 52/204.593; 52/204.5; 52/741.4

(57) ABSTRACT

There is provided a thermal window assembly for increased insulation and energy efficiency, both in cold or warm climates. The window assembly comprises an external frame and an internal frame. The internal frame has grooves therein for receiving one or more thermal panels.

### CROSS REFERENCE TO RELATED APPLICATION

This application claims priority from Provisional Patent Application No. 61/489,384 filed May 24, 2011. The entire subject matter of the application is incorporated herein by reference.

### TECHNICAL FIELD

The present disclosure relates to energy conservation of facilities (both commercial and private). In particular, it relates to reduction of heat conduction through windows.

### SUMMARY

In one aspect of the disclosure, there is provided a thermal window assembly for reducing thermal conduction comprising: a) an external frame; b) an internal frame having means for receiving one or more thermal panels, each thermal panel affixed to the internal frame; wherein the external frame is affixed to an existing window frame; the internal frame is affixed to the external frame.

### BRIEF DESCRIPTION OF FIGURES

FIG. 1 illustrates an exploded perspective view of an embodiment of the thermal window assembly.

FIG. 2 illustrates a cutaway perspective view of the thermal assembly shown in FIG. 1.

FIG. 3 illustrates an enlarged view of the perspective shown in FIG. 2.

FIG. 4 illustrates partial placement of a thermal window assembly onto an existing window frame.

FIG. 5 illustrates a portion of two thermal window assemblies joined together.

### DETAILED DESCRIPTION

The following is given by way of illustration only and is not to be considered limitative. Many apparent variations are possible without departing from the scope thereof.

Disclosed herein is a thermal window assembly for reduction of heat conduction there through. The assembly can be used in either cold or warm climates.

When used in cold climates, the thermal window assembly reduces the loss of heat that occurs through via conduction through windows. When used in warm climates, the thermal window assembly reduces heat conduction from outside to inside windows (within a dwelling), thereby providing greater efficiency for air-conditioned facilities.

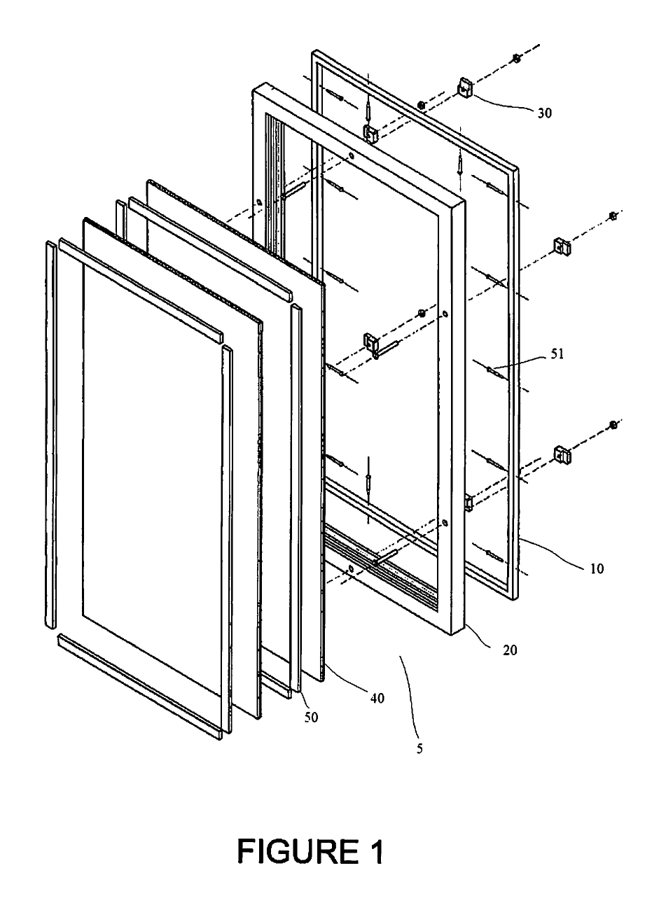

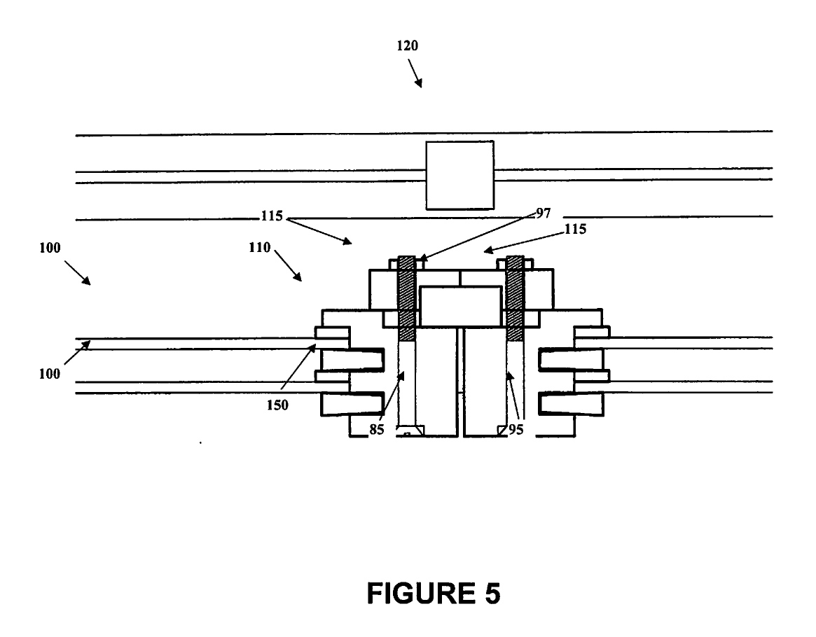

FIG. 1 illustrates an exploded perspective view of an embodiment of the thermal window assembly (5). An external frame (10) is affixed to an existing window frame (not shown), by example, with screws (51). The external frame (10) is attached to an internal frame (20), by, for example, a series of clamps (30) . The internal frame contains one or more grooves, each groove designed to receive a heat-insulation panel (40). Each panel (40) is affixed to the internal frame (20) along with a thin affixing strip (50), such as a batten. The strip (50) seals the joint between the panel (40) and the internal frame (20), thereby preventing heat conduction through the point of contact between the panel (40) and internal frame (20). The strip (50) also helps to keep the thermal panel (40) in place. In addition, the panel (40) can have an adhesive strip attached thereto on the side opposite to that facing the strip (50). This arrangement is shown in FIG. 5, and discussed below.

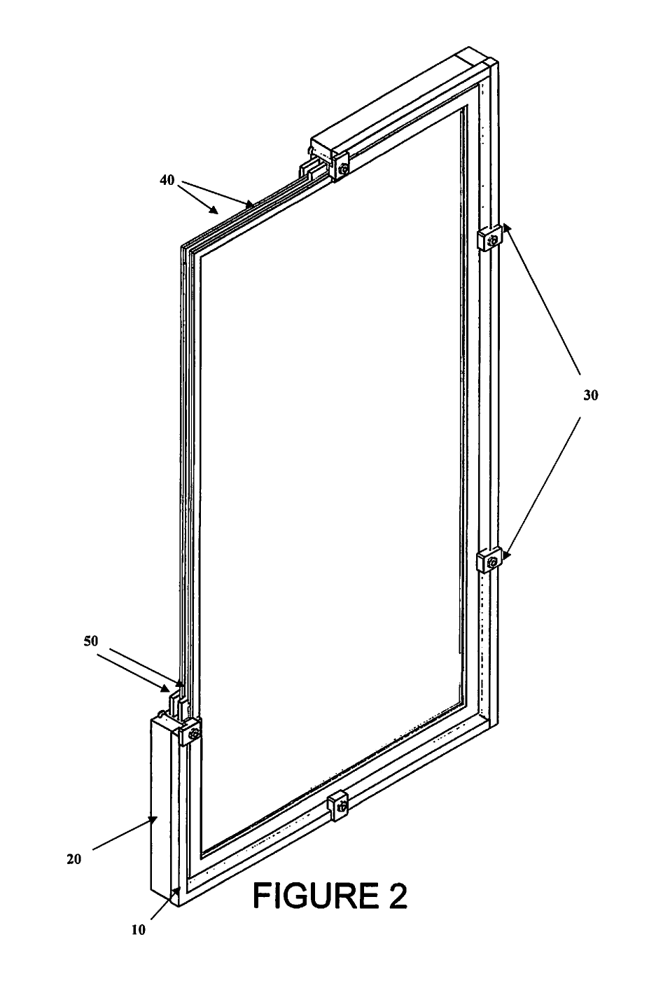

FIG. 2 illustrates a cutaway perspective view of the thermal assembly shown in FIG. 1. The external frame (10) is affixed to the internal frame (20), while each thermal panel (40) is fitted into the internal frame (10), along with a strip (50).

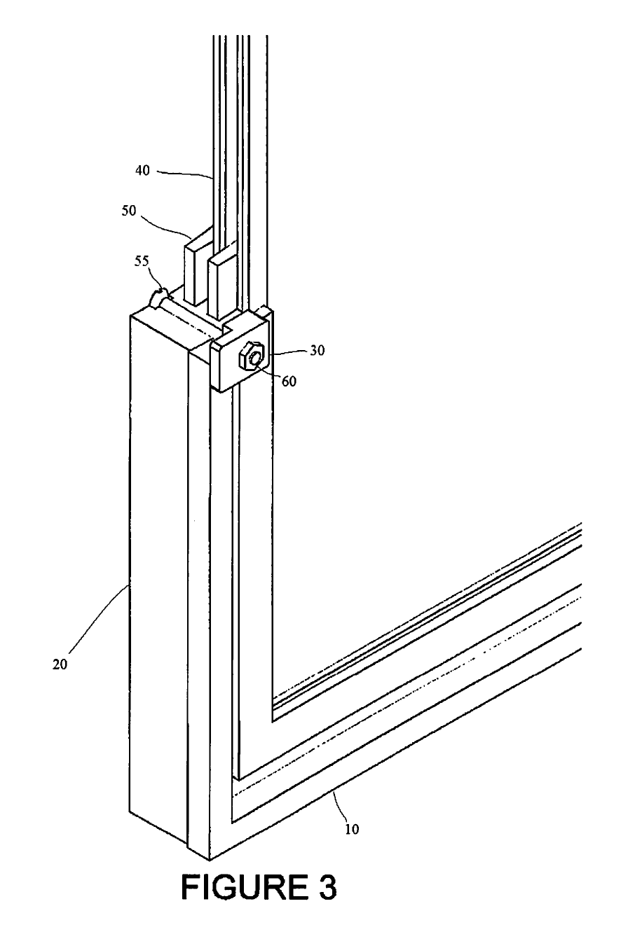

FIG. 3 illustrates an enlarged view of the perspective shown in FIG. 2, with particular emphasis on the connection between the internal frame (20) and the external frame (10). Here, the attachment means between the external frame (10) and the existing window frame are not shown. The internal and external frames (10, 20) are affixed using conventional means, such as a screw (55), nut (60) and clamp (30). The panels (40) are affixed to the internal frame (20) with the use of strips (50).

The assembly (5) shown in FIGS. 1-3 is affixed to an existing window frame via the external frame (10).

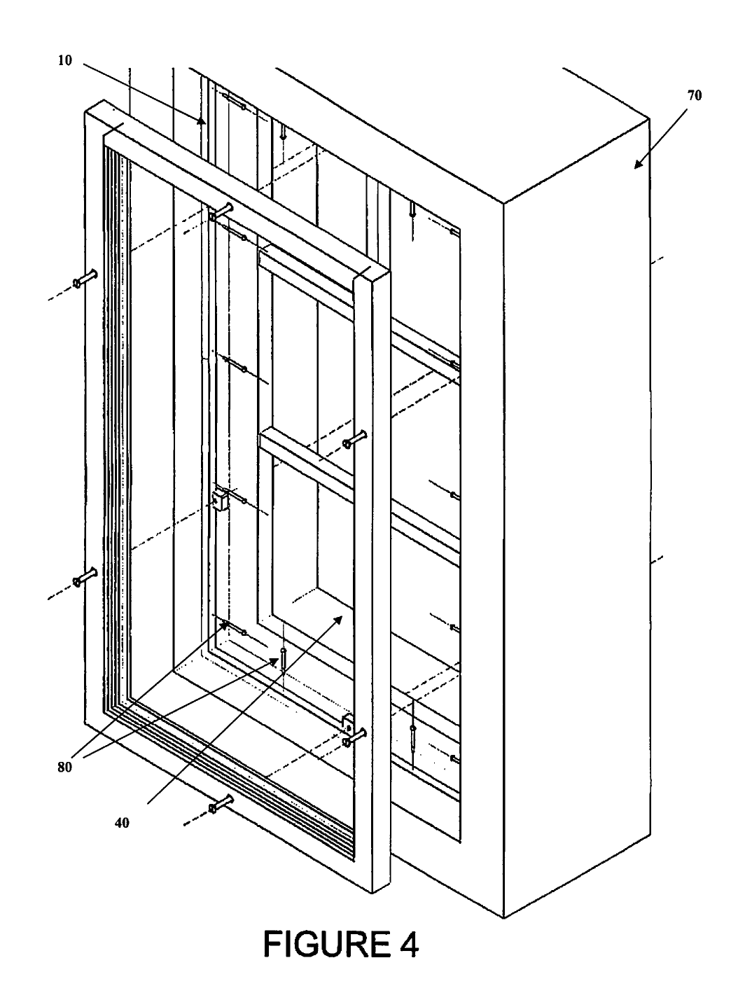

FIG. 4 illustrates partial placement of a thermal window assembly onto an existing window frame (70). The external frame (10) is attached to the existing window frame (70) with a series of screws (80). However, it is understood that other suitable means, such as adhesive tape, and the like, can be used to secure the external frame (10) to the existing window frame (70). The internal frame (20), panels (40) and sealing strips (50) are assembled as shown into a sub-assembly (90), which is then affixed to the external frame (10), using, for example a series of clamps (30), screws (55) and nuts (60).

Alternatively, the thermal window assembly can be moulded onto a window frame at the time of construction of the window frame.

The thermal window assembly is dimensioned to fit within a pre-existing window frame.

The internal frame may be made of any sturdy material. For example, it can be made of wood, plastic or aluminium. The internal frame may be optionally coloured to match the decor of the interior.

Similarly, the external frame may be made of any sturdy material. For example, it can be made of wood, plastic or aluminium. The external frame may be optionally coloured to match the decor of the interior.

The internal and external frames can be assembled on site. As shown in FIGS. 1-4, each frame is assembled from a series of individual units.

The thermal window assembly comprises one or more panels. Each panel provides for visibility from within the facility, looking outwards. Furthermore, each panel is heat-insulating, and can be, for example, acrylic (e.g. Plexiglass™ or Lexan™), or tempered glass. The face of each panel closest to the internal frame may be coated with a reflective material, for example, to reflect rays of sunlight. Such an embodiment is used in warm climates, to increase the efficiency of cooling of a facility.

The minimum number of panels is one. While there is no maximum, in one embodiment, the number of panels is two (see FIGS. 1-4). The panel closest to the internal frame, combined with the existing window pane, creates a first air gap, which serves to insulate against heat conduction. Each additional panel provides an additional air gap.

The R-value of the thermal window assembly depends on the number of heat-insulating panels used). The minimum R-value is about R4, with each additional panel contributing about an additional R4 value.

The thermal window assembly can be adapted to large existing window frames, by connecting a series of smaller thermal window assemblies to form one large thermal window assembly. The external perimeter of the large assembly is then affixed to the existing window frame.

FIG. 5 illustrates a portion of two thermal window assemblies joined together. Two internal frames (85, 95) are joined together via a joining external batten (97) and clamps (115). For clarity, the thermal panes (100), adhesive strips (110), and sealing strips (150) of the internal frame (85) are shown. The existing window (120) is shown above the thermal window assembly.

The thermal window assembly is attached to an existing window frame by first attaching the external frame, unit by unit, to the existing window frame, by suitable attaching means. The external frame has the same dimensions as the opening of the existing window frame, to provide for a snug fit between the external frame and the existing window frame.

Next, the internal frame is attached to the external frame using a suitable attachment means. The internal frame should have dimensions at most, equal to those of the external frame. The internal frame can be attached unit by unit, or, pre-assembled, and then attached as an assembled frame to the internal frame. An optional adhesive strip can be placed between the internal and external frames, to provide for additional sealing.

After, the innermost thermal panel is fitted into the innermost groove of the internal frame. A strip of adhesive can be affixed on the outward face of the thermal panel, along each edge of the thermal panel. A strip or batten is then wedged into the groove, on the inner-face of the thermal panel, along each edge thereof This step is repeated for all additional panels.

The foregoing has constituted a description of specific embodiments showing how the invention may be applied and put into use. These embodiments are only exemplary.

1. A thermal window assembly for reducing thermal conduction comprising:
a) an external frame;
b) an internal frame having means for receiving one or more thermal panels,
each thermal panel affixed to the internal frame; wherein the external frame is affixed to an existing window frame; the internal frame is affixed to the external frame.

2. The thermal window assembly of claim 1, wherein the number of thermal panels is two.

3. The thermal window assembly of claim 1, wherein the external frame is moulded onto the existing frame.

4. The thermal window assembly of claim 1, wherein the internal frame is made of a material selected from the group consisting of wood, plastic and aluminium.

5. The thermal window assembly of claim 1, wherein the external frame is made of a material selected from the group consisting of wood, plastic and aluminium.

6. The thermal window assembly of claim 1, wherein each of said one or more thermal panels is made of a material selected from the group consisting of acrylic and tempered glass.

7. The thermal window assembly of claim 1, wherein a first one of the one or more thermal panels is coated with reflective material.

8. The thermal window assembly of claim 1, further comprising an adhesive strip between the internal frame and the external frame.

9. The thermal window assembly of claim 1, wherein the internal panel comprises grooves for receiving the one or more thermal panels.

10. The thermal window assembly of claim 9, wherein the one or more thermal panels are fitted into the grooves.

11. A method of manufacture for a thermal window assembly, comprising:
attaching an external frame to an existing window frame, the external frame having the same dimensions as the opening of the existing window frame;
attaching the internal frame to the external frame;
fitting one or more thermal panels within the internal frame.

12. The method of manufacture of claim 11, wherein the internal frame has dimensions equal to those of the external frame.

13. The method of manufacture of claim 11, wherein the internal frame is pre-assembled.

14. The method of manufacture of claim 11, further comprising the step of placing an adhesive strip between the internal frame and the external frame.

15. The method of manufacture of claim 11, wherein the internal frame comprises grooves for receiving thermal panels.

16. The method of manufacture of claim 15, wherein the step of fitting one or more thermal panels within the internal frame comprises fitting the one or more thermal panel within the grooves.

17. The method of manufacture of claim 11, wherein the step of fitting one or more thermal panels within the internal frame comprises placing an adhesive strip on the outward face of each one of the one or more thermal panels.

18. The method of manufacture of claim 17, wherein the step of fitting one or more thermal panels within the internal frame comprises placing, for each one of the one or more thermal panels, a batten into the corresponding groove.
